(19) United States
(12) Patent Application Publication
(10) Pub. No.: US 2005/0075974 A1
(43) Pub. Date: Apr. 7, 2005

(54) Methods and systems for transferring funds to direct-deposit accounts

(75) Inventor: Paul Turgeon, Fort Collins, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corporation, Englewood, CO (US)

(21) Appl. No.: 10/680,081

(22) Filed: Oct. 6, 2003

(51) Int. Cl. G06F 17/60

(52) U.S. Cl. 705/39

(57) ABSTRACT

Methods and systems are provided for depositing funds in a deposit account. A request to credit a specified amount to the deposit account is received at a node of a financial-services network that has multiple interconnected nodes. The request includes an indirect identification of the deposit account. A direct identification of the deposit account is determined from the indirect identification and from a nonpublic mapping of a indirect identifications to identifications of respective deposit accounts. An instruction is issued to credit the deposit account with the specified amount in accordance with the determined direct identification.

### BACKGROUND OF THE INVENTION

This application relates generally to information security. More specifically, this application relates to methods and systems using information security to transfer funds to deposit accounts.

There are a number of instances in which parties wish to deposit funds directly to other's accounts. In some of these instances, the parties are trusted parties, in which case a holder of the account may provide those parties with the primary account number for the deposit account and identify the financial institution where it is held. This is often done, for example, with employers who arrange for direct deposit of employee paychecks and similar applications.

In other instances, however, the parties are not trusted parties, and the holder of the account is understandably reluctant to disclose his account information. This may occur, for example, in the context of refunds to be made by parties in certain commercial transactions, in the context of electronic commercial transactions, and in a variety of other applications. Traditionally, the account holder must choose between refusing to disclose his account information, in which case the convenience of a direct deposit is forgone, or to accept an unknown level of risk that such personal financial information will be used improperly. Because of the high level of discomfort many individuals have with such disclosure, particularly with parties who are not known to be trustworthy, a very large number of potential direct-deposit transactions have simply not been made; they have instead been substituted with much less convenient and less timely alternatives, such as through preparation and mailing of checks or other negotiable instruments.

There is accordingly a general need in the art for improved methods and systems that permit deposits to be made directly into deposit accounts while ensuring the security and confidentiality of private account information.

### BRIEF SUMMARY OF THE INVENTION

Embodiments of the invention thus provide methods and systems that permit the deposit of funds in a deposit account without disclosing private account information to a party who may be initiating the deposit. Embodiments of the invention make use of a nonpublic mapping for a plurality of deposit accounts from indirect identifications of those accounts to direct identifications of those accounts. Thus, the initiating party may supply the indirect identification at one node of a financial-services network, with the mapping being used to supply the financial institution that maintains the account with the direct identification.

Thus, in a first set of embodiments, a method is provided for depositing funds in a deposit account. A request to credit a specified amount to the deposit account is received at a node of a financial-services network that comprises a plurality of interconnected nodes. The request includes an indirect identification of the deposit account. A direct identification of the deposit account is determined from the indirect identification and from a nonpublic mapping of a plurality of respective indirect identifications to respective direct identifications of respective deposit accounts. An instruction is issued to credit the deposit account with the specified amount in accordance with the determined direct identification.

Different architectures for the financial-services network may be supported. For example, in some such embodiments, the financial-services network comprises a hub node and a plurality of ordinary nodes, each of which is in direct communication with the hub node. In some instances, the request may be received at the hub node. In other embodiments, each of the plurality of the interconnected nodes is in direct communication with a second plurality of the interconnected nodes. The financial-services network may also be provided in communication with other financial-services networks. For instance, in one embodiment, receiving the request may comprise receiving the request as routed from a second financial-services network that comprises a second plurality of interconnected nodes. Alternatively, issuing the instruction to credit the deposit account may comprise transmitting the instruction for routing over a second financial-services network that comprises a second plurality of interconnected nodes. In some cases, at least some of the nodes may have automated teller machines (“ATMs”), in which case the financial-services network comprises an ATM network.

The nonpublic mapping may be maintained in one embodiment at the node at which the request is received. In another embodiment, the nonpublic mapping may comprise a plurality of nonpublic mappings of respective indirect identifications to respective direct identifications of respective deposit accounts. Each such nonpublic mapping may be maintained at a different node comprised by the financial-services network. At least part of the nonpublic mapping may be encrypted. In some instances, the request may further include an identification of a financial institution that maintains the deposit account. Issuing the instruction to credit the deposit account may then comprise transmitting the instruction for routing to a node comprised by the financial institution. In other instances, the node at which the request is received may be comprised by a financial institution that maintains the deposit account.

Examples of indirect identifications that may be used in embodiments of the invention include a name of a holder of the deposit account, a name of a relative of the holder of the deposit account, a date meaningful to the holder of the deposit account, and a truncated portion of a numerical identifier of the holder of the deposit account. Examples of the direct identification include a primary account number for the deposit account and perhaps also a routing number identifying a financial institution that maintains the deposit account.

The methods of the present invention may also be embodied in a computer-readable storage medium having a computer-readable program embodied therein for directing operation of a computational device comprised by a node of the financial-services network. The computational device includes an input device, a communications system, a processor, and a storage device. The computer-readable program includes instructions for operating the computational device to deposit funds in a deposit account in accordance with the embodiments described above.

### BRIEF DESCRIPTION OF THE DRAWINGS

A further understanding of the nature and advantages of the present invention may be realized by reference to the remaining portions of the specification and the drawings wherein like reference numerals are used throughout the several drawings to refer to similar components. In some instances, a sublabel is associated with a reference numeral and follows a hyphen to denote one of multiple similar components. When reference is made to a reference numeral without specification to an existing sublabel, it is intended to refer to all such multiple similar components.

FIGS. 1A-1H provide schematic illustrations of different network configurations that may be used for financial networks in embodiments of the invention;

FIG. 2 provides a schematic illustration of interconnected financial networks that may be used in some embodiments of the invention;

FIGS. 3A and 3B provide illustrations of a flow of information through a financial network in implementing certain embodiments of the invention;

FIG. 4 provides a flow diagram summarizing methods for depositing funds in a deposit account according to embodiments of the invention; and

FIG. 5 is a schematic illustration of a computer system on which methods of the invention may be embodied.

### DETAILED DESCRIPTION OF THE INVENTION

Embodiments of the invention provide methods and systems for depositing funds in deposit accounts without compromising the security and confidentiality of private account information. Such deposits may be made using embodiments of the invention even by those other than a “holder” of the account, which is intended to refer herein to any person having rights to make withdrawals from the account. As used herein, a “deposit account” is intended to refer to any financial account to which funds may be deposited for the benefit of the account holder. The term is intended to encompass both time-deposit accounts and transaction accounts. Examples of deposit accounts thus includes checking accounts, savings accounts, demand-deposit accounts, certificate accounts, share accounts, money-market mutual-fund accounts, negotiable withdrawal order accounts, and the like.

The capability of making deposits in this way is provided in part by drawing a distinction between “indirect information” and “direct information” that may be used to identify deposit accounts. In particular, direct information is intended to refer to a unique identifier of the deposit account that is used by a financial institution that maintains the account in identifying that account. This direct information is usually shared by the financial institution with the account holder, and may sometimes be shared with third parties by the account holder, but is generally otherwise viewed as private information between the financial institution and account holder. Merely by way of example, such direct information could comprise a primary account number (“PAN”) used by the financial institution in identifying the account. In some instances, the direct information might also include a routing or transit number used to identify the financial institution itself.

In contrast, indirect information is intended to refer to any information that is not direct information and may be used, such as described herein, to identify the deposit account. In some instances, such indirect information may identify the account holder, from which the financial institution is able to identify the account. Usually, the indirect information that is used in embodiments of the invention enjoys an intermediate level of confidentiality, not being readily available publicly to third parties but not being viewed by the account holder as as sensitive as the direct information. For example, in some embodiments the indirect information comprises a name of a relative of the holder, such as a mother's or grandmother's maiden name. In other embodiments, the indirect information comprises a date meaningful to the holder, such as a birth date, birth date of a child or other relative, anniversary date, and the like. In still other embodiments, the indirect information comprises a truncated portion of a numerical identifier of the holder, such as the last four digits of a Social Security Number, and the like.

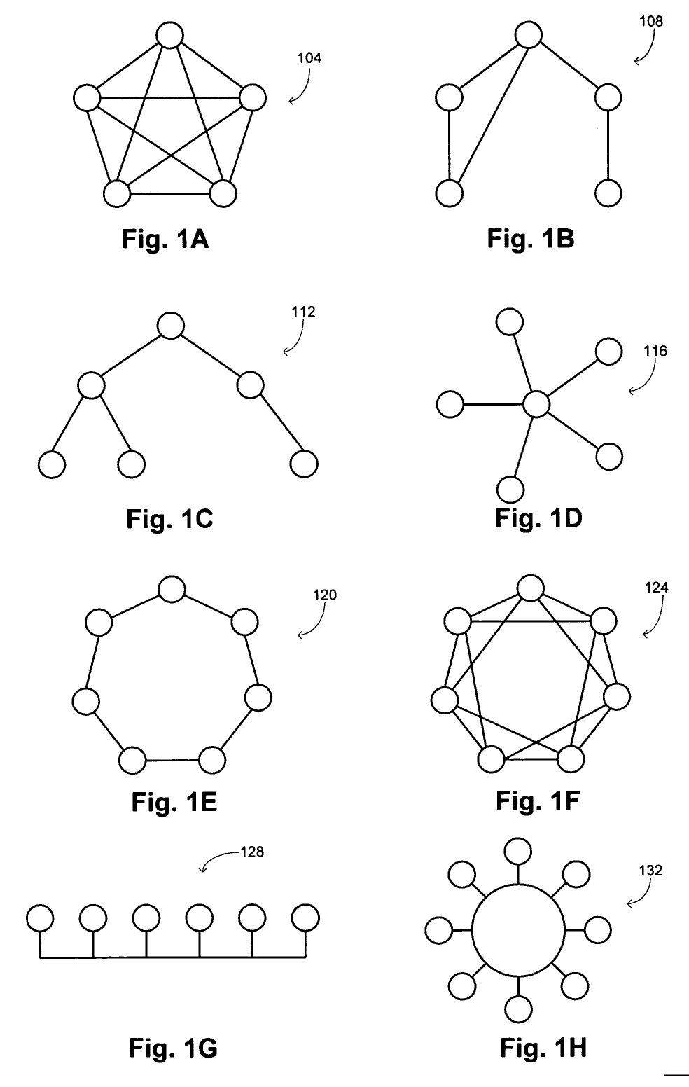

According to embodiments of the invention, a nonpublic mapping is provided between the indirect information and the direct information that may be applied at a node within a financial-services network. The invention is not restricted to a particular architecture for the network and, indeed, FIGS. 1A-1H provide schematic illustrations for a variety of different types of architectures that may be used in different embodiments, although still other architectures will be known to those of skill in the art. Each of the architectures shown includes a plurality of nodes, which may correspond to any of a variety of different access points for the network, and a plurality of communication lines, which may be provided through any appropriate mechanism, including through electrical communication lines, optical communication lines, wireless communications protocols, and the like. Examples of the node access points to the networks include ATMs, data-entry devices located at physical branches of financial institutions or at administrative offices of financial institutions, internet gateway points permitting electronic access to the network, and the like. For example, a particular network might be provided in the form of a network that permits financial transactions to be executed between different financial institutions. Some of the nodes of the network might be comprised by different financial institutions to process those transactions, some of the nodes might be comprised by ATMs that are individually affiliated with one of those financial institutions, and still other of the nodes might be comprised by access points at merchant locations used to perform debit transactions for an account directly. Any financial-services network that includes a node comprised by an ATM is referred to herein as an “ATM network.”

In FIGS. 1A-1H, the nodes are designated schematically with circles, and lines are drawn between the circles to represent the communication lines. FIG. 1A provides an example of a fully connected network 104 in which a communication line exists to connect every node comprised by the network to every other node comprised by the network. Such a network has the advantage that communications may be made directly between any two nodes, but requires a large number of communication lines. Other architectures provide fewer communication lines for the same number of nodes so that some communications are routed through multiple nodes. For example, FIG. 1B provides an example of a partially connected network 108. Still other architectures may be used, such as the tree network 112 shown in FIG. 1C or the star network 116 shown in FIG. 1D. The star network 116 is an example of a network that includes a hub node, shown at the center, and a plurality of ordinary nodes, each of which is in direct communication with the hub node. In other implementations, a network may comprise a plurality of hub nodes, in which case it is generally referred to a “multihub network.” In other implementations, the network may comprise a ring network, shown in FIG. 1E as a single-link ring network 120 and in FIG. 1F as a double-link ring network 124. Examples of bus networks are provided in FIGS. 1G and 1H, which respectively show a linear-bus network 128 and a ring-bus network 132. Still other examples of networks include multipartite networks in which sets of nodes are grouped such that communications are provided distinctly among the plurality of groups.

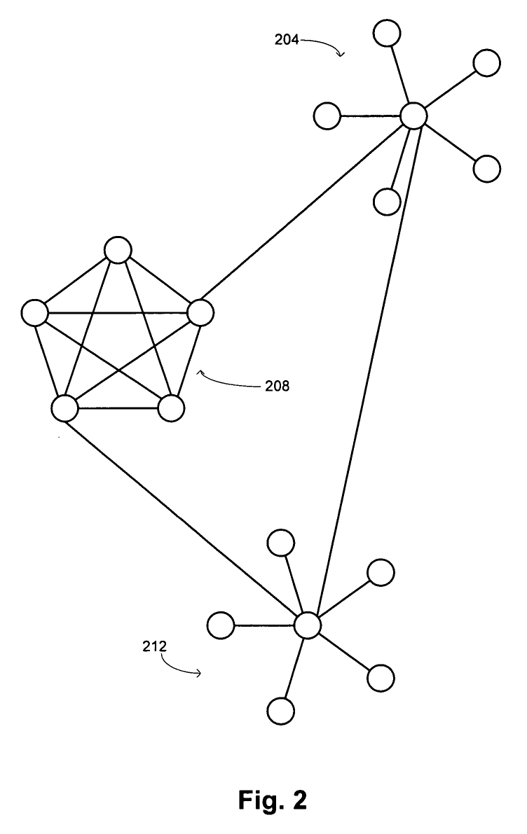

In some embodiments, communications may be provided among a plurality of financial-services networks, such as illustrated schematically in FIG. 2. While the architecture shown in FIG. 2 is described herein for convenience as having a plurality of distinct networks, it may alternatively be considered to be a single network having a plurality of identifiable subnetworks. An architecture such as shown in FIG. 2 may arise from a later attempt to interconnect previously structured independent networks. For example, two of the networks shown in FIG. 2, say the fully connected network 208 and star network 212, may correspond to independent financial-services networks provided in North America and covering substantially the same geographic scope, while star network 204 corresponds to a European financial-services network. These networks may have been created independently and then later been interconnected. In another example, each of the independent networks might correspond to a network covering a different geographic area, such as with star network 204 covering Europe, fully connected network 208 covering Canada, and star network 212 covering the United States. Again, these networks may only have been interconnected after being created independently. Embodiments of the invention may accommodate such multiple-network architectures as described in further detail below, with communications between distinct networks being routed through node connections between networks.

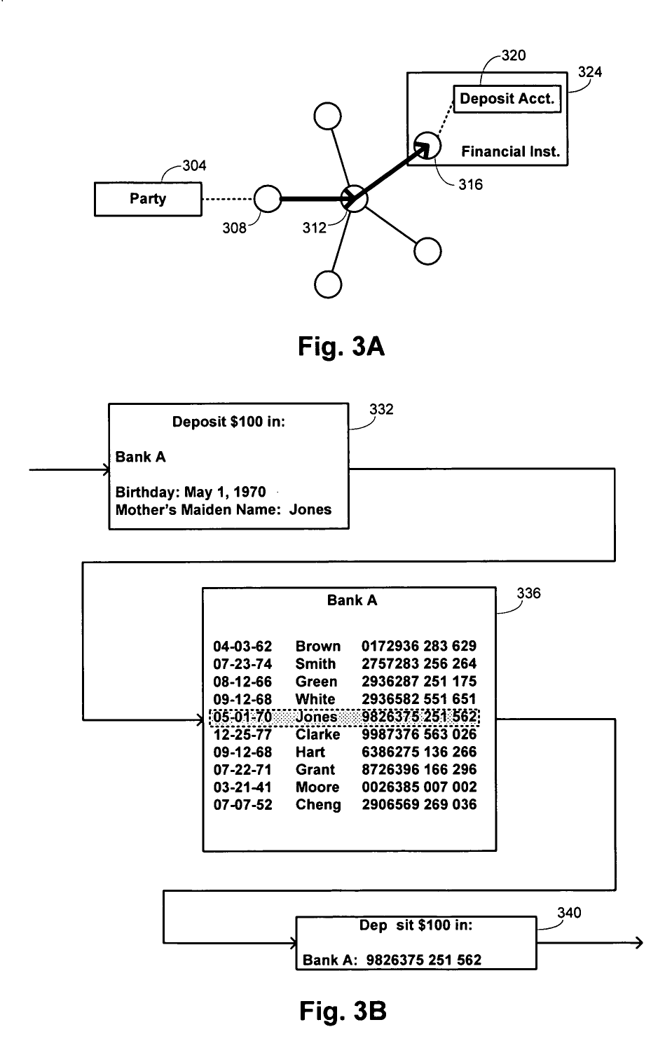

An illustration is provided in FIGS. 3A and 3B using a specific example to show how information may be routed through a financial network. While the example uses a star network for illustrative purposes, it will be appreciated that the same principles may be used for any network architecture, including architectures that comprise a plurality of distinct networks as illustrated in FIG. 2. A party 304, usually other than the account holder, initiates a deposit with the network arrangement at one of the nodes 308. This request is transmitted through the network arrangement to a node 316 comprised by a financial institution 324 that maintains the deposit account 320. The party 304 supplies an indirect identification of the deposit account 320, with this information being converted at some point during transmission within the network to a direct identification of the deposit account 320. The node 304 at which the party interacts may generally be any type of node supported by the network. For instance, the party may provide the deposit information directly to the node at an ATM node, an Internet-banking node, or the like. Alternatively, the deposit information could be provided indirectly by conveying it to a teller at a financial institution for input by the teller, by conveying it to an administrative staff member by telephone or electronically for input by the administrative staff member, or the like.

In the illustration, the conversion of the indirect identification to the direct identification is effected at the hub node 312, but may more generally take place at any node. The network node at which such conversion takes place may reflect an accommodation of competing concerns, and the point at which this accommodation is made may differ in different embodiments. For example, as is evident from the description that follows, the amount of information that need be maintained by the conversion node is greater if the conversion takes place closer in the network to the node 308 where the indirect information is received. At the same time, however, current financial-services networks are generally equipped for transmission of the direct information but not for the indirect information; fewer modifications are needed to such existing network infrastructures if the conversion takes place closer in the network to the node 316 where the deposit is to be effected.

An example of a data record that may be provided by the party 304 to node 308 is shown at block 332 in FIG. 3B. This data record includes an identification of the financial institution where the deposit account is held, i.e. at Bank A, as well as the indirect identification of the deposit account. In some instances, the identification of the financial institution may be unnecessary, such as in embodiments where the indirect identification is sufficient also to identify the financial institution or where the network is limited in scope to a single financial institution. In this example, the indirect identification consists of a birth date for the holder of the deposit account and maiden name of the holder's mother, but other types of indirect identification may alternatively be used.

At node 312, the indirect identification in the data record is compared with a nonpublic mapping 336 that defines a relationship between a plurality of indirect identifications to direct identifications of respective deposit accounts. The security and confidentiality of the direct identification is maintained at least in part through the nonpublic character of the mapping. In some cases, additional security may also be provided through a variety of mechanisms, such as by encrypting all or a portion of the mapping, periodically changing what qualifies as indirect identifications, and the like. Also, while the exemplary mapping shows only a single indirect identification for each deposit account, in other embodiments multiple indirect identifications may be provided in the mapping for some or all of the deposit accounts. Such multiple indirect identifications permit different parties 304 to use different indirect identifications to identify the same deposit account, which may be useful in cases where the account holder wishes to exercise greater selective discretion over which information to disclose to such parties 304.

In the illustrated example, the mapping 336 associates combinations of holder birth dates and mother's maiden names with account numbers, which thereby correspond to the direct identifications of deposit accounts. Thus, a processor at node 312 uses the mapping information to generate an instruction 340 to credit the deposit account with the specified amount, identifying the deposit account with the direct identification. This instruction is transmitted through the remainder of the network until it is delivered to the node 316 comprised by the financial institution 324. While FIG. 3A shows a simplified configuration in which there is a single node-to-node transmission of the initial data record 332 having the indirect identification and a single node-to-node transmission of the instruction 340 having the direct identification, there may more generally be zero or more node-to-node transmissions of either structure depending on the position of the conversion node. Furthermore, such node-to-node transmissions may take place within a single network or may take place across networks as internetwork transmissions where a network architecture comprises a plurality of distinct networks.

Also, while the configuration shown in FIG. 3A provides an architecture having only a single conversion node, it should be appreciated that some architectures may include multiple nodes that may act as conversion nodes. In some instances, each of a plurality of conversion nodes may comprise different mapping information. In one embodiment, for example, the mapping information for each of a plurality of financial institutions is maintained at a different node; each such node functions as a conversion node for credit requests that identify deposit accounts maintained at the respective financial institution. In other instances, some or all of the mapping information may be duplicated at multiple nodes. Which of multiple nodes that acts as the conversion node for a specific credit request may depend, at least in part, on proximity to the origination node along a path followed by that request through the network, although any of those nodes could function as the conversion node in certain circumstances.

It is noted that access to the mapping is generally used only where a request made for a deposit to an account. Other types of transactions are typically prevented from being executed only with the indirect information, requiring instead that the direct information be provided by the individual attempting to initiate the transaction. For example, a withdrawal from an account, a transfer of funds from an account, and the like will normally require that the individual provide the direct information. This precludes an individual from withdrawing funds from another's account simply based on relatively insecure indirect information.

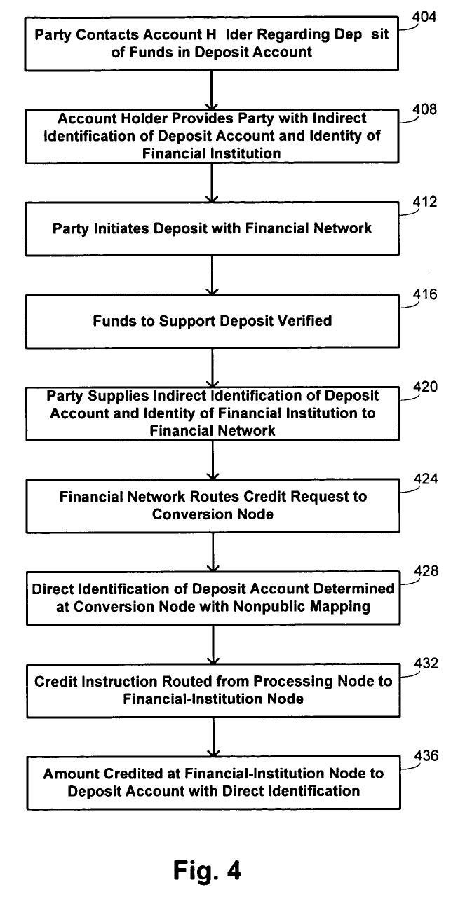

Methods for depositing funds in a deposit account are thus summarized for a variety of embodiments with the flow diagram shown in FIG. 4. Such methods may begin as indicated at block 404 with a party contacting the account holder regarding a deposit of funds in the deposit account. Such contact may be initiated by the party, by the account holder, or by another party, and may reflect a desire on the part of the party to make a refund or other payment to the account holder. The account holder provides the party with the indirect identification of the deposit account and perhaps also with the identity of the financial institution at block 408. This information is then used by the party to initiate the deposit with the financial network as indicated at block 412, such as by initiating the deposit directly with an ATM or Internet-banking connection or initiating it with an intermediary such as a teller or other employee of the financial institution.

In many instances, it will be verified that funds are available to support the deposit, as indicated at block 416. For example, the party may need to provide cash, his own account number to be debited, an approved credit instrument, or similar funds support to a teller, automated device, or other person or device in order to support the deposit request. Execution of the deposit request may be denied in the event the party is unable to supply the necessary funds. At block 420, the party additionally supplies the indirect identification of the deposit account and perhaps also the identity of the financial institution so that the financial network may route a request to credit the deposit account to the conversion node, as indicated at block 424. The conversion node is the node at which the direct identification of the deposit account is determined at block 428 with the nonpublic mapping as described above.

The conversion node thus performs at least three functions in embodiments of the invention. It receives the request to credit the deposit account, it determines the direct identification from the nonpublic mapping, and it issues the instruction to credit the deposit account. In instances where the request originates in another financial-services network, its receipt at the conversion node may be direct from the other network or may be routed through one or more intermediate nodes in the origination-node network, the conversion-node network, or even in intermediate networks. In the event that the conversion node is comprised by the financial institution that maintains the deposit account, issuing the instruction to credit the deposit account may be performed directly by that financial institution to perform the credit. In other instances, the credit instruction may be routed from the conversion node to a node that is comprised by the financial institution, as indicated at block 432. The financial-institution node may also be located in a different financial network than the conversion node, in which case the routing may include internetwork transmissions.

Once the credit instruction is received by the financial institution by being received at a node comprised by the financial institution, the direct identification of the deposit account may be used to identify where to deposit the funds. The specified amount is accordingly credited to the deposit account as indicated at block 436.

Each of the nodes comprised by the financial-services network may include a computational device equipped to implement the appropriate communications to transfer the requests and instructions through the network as described above. In addition, those computational devices may be equipped in different ways to process transactions. For instance, one such computational device may comprise an ATM, which includes both structural components and programming instructions to enable it to accept deposits, process withdrawals, transfer funds, and the like. In other cases, the computational device may comprise a teller-station terminal equipped to accept data and processing instructions to record transactions executed by a teller. In still other cases, the computational device may comprise an Internet gateway having connections and processing instructions to transmit financial-transaction information securely. Some of the nodes may also comprise computational devices whose function is completely internal to network and that are not equipped for external interactions.

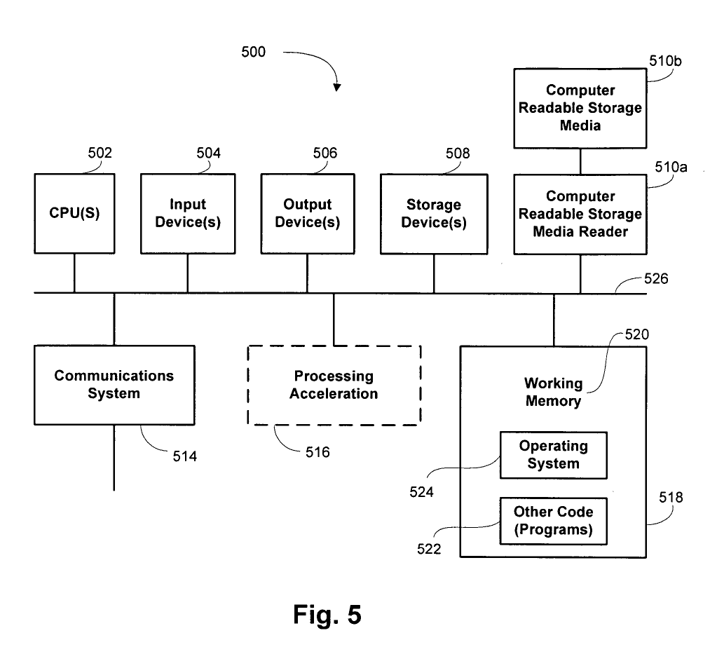

A general structure for such computational devices is provided with a schematic illustration in FIG. 5, in which the computational device is denoted generally by reference numeral 500. FIG. 5 broadly illustrates how individual system elements may be implemented in a separated or more integrated manner. The computational device 500 is shown comprised of hardware elements that are electrically coupled via bus 526, including a processor 502, an input device 504, an output device 506, a storage device 508, a computer-readable storage media reader 510a, a communications system 514, a processing acceleration unit 516 such as a DSP or special-purpose processor, and a memory 518. In the case of a conversion node, the storage device 508 may be used to store the nonpublic mapping. The computer-readable storage media reader 510a is further connected to a computer-readable storage medium 510b, the combination comprehensively representing remote, local, fixed, and/or removable storage devices plus storage media for temporarily and/or more permanently containing computer-readable information. The communications system 514 may comprise a wired, wireless, modem, and/or other type of interfacing connection and permits data to be exchanged with other nodes comprised by the network to implement embodiments as described above.

The computational device 500 also comprises software elements, shown as being currently located within working memory 520, including an operating system 524 and other code 522, such as a program designed to implement methods of the invention. It will be apparent to those skilled in the art that substantial variations may be made in accordance with specific requirements. For example, customized hardware might also be used and/or particular elements might be implemented in hardware, software (including portable software, such as applets), or both. Further, connection to other computing devices such as network input/output devices may be employed.

Thus, having described several embodiments, it will be recognized by those of skill in the art that various modifications, alternative constructions, and equivalents may be used without departing from the spirit of the invention. Accordingly, the above description should not be taken as limiting the scope of the invention, which is defined in the following claims.

1. A method for depositing funds in a deposit account, the method comprising:
receiving a request to credit a specified amount to the deposit account at a node of a financial-services network that comprises a plurality of interconnected nodes, wherein the request includes an indirect identification of the deposit account;
determining a direct identification of the deposit account from the indirect identification and from a nonpublic mapping of a plurality of respective indirect identifications to respective direct identifications of respective deposit accounts; and
issuing an instruction to credit the deposit account with the specified amount in accordance with the determined direct identification.

2. The method recited in claim 1 wherein the financial-services network comprises a hub node and a plurality of ordinary nodes, wherein each ordinary node is in direct communication with the hub node.

3. The method recited in claim 2 wherein the node at which the request is received is the hub node.

4. The method recited in claim 1 wherein each of a plurality of the interconnected nodes is in direct communication with a second plurality of the interconnected nodes.

5. The method recited in claim 1 wherein the nonpublic mapping is maintained at the node at which the request is received.

6. The method recited in claim 1 wherein the nonpublic mapping comprises a plurality of nonpublic mappings of respective indirect identifications to respective direct identifications of respective deposit accounts, each such nonpublic mapping being maintained at a different node comprised by the financial-services network.

7. The method recited in claim 1 wherein receiving the request comprises receiving the request as routed from a second financial-services network that comprises a second plurality of interconnected nodes.

8. The method recited in claim 1 wherein issuing the instruction to credit the deposit account comprises transmitting the instruction for routing over a second financial-services network that comprises a second plurality of interconnected nodes.

9. The method recited in claim 1 wherein the network comprises an automatic-teller-machine network having least some nodes comprised by automatic teller machines.

10. The method recited in claim 1 wherein receiving the request comprises receiving the request as routed from an initiating automatic teller machine.

11. The method recited in claim 1 wherein the request does not include the direct identification.

12. The method recited in claim 1 wherein:
the request further includes an identification of a financial institution that maintains the deposit account; and
issuing the instruction to credit the deposit account comprises transmitting the instruction for routing to a node comprised by the financial institution.

13. The method recited in claim 1 wherein the node at which the request is received is comprised by a financial institution that maintains the deposit account.

14. The method recited in claim 1 wherein the indirect identification is selected from the group consisting of a name of a holder of the deposit account, a name of a relative of the holder of the deposit account, a date meaningful to the holder of the deposit account, and a truncated portion of a numerical identifier of the holder of the deposit account.

15. The method recited in claim 1 wherein the direct identification of the deposit account comprises a primary account number for the deposit account.

16. The method recited in claim 15 wherein the direct identification of the deposit account further comprises a routing number identifying a financial institution that maintains the deposit account.

17. The method recited in claim 1 wherein at least a portion of the nonpublic mapping is encrypted.

18. A computer-readable storage medium having a computer-readable program embodied therein for directing operation of a computational device comprised by a node of a financial-services network that comprises a plurality of interconnected nodes, the computational device including an input device, a communications system, a processor, and a storage device, wherein the computer-readable program includes instructions for operating the computational system to deposit funds in a deposit account in accordance with the following:
receiving a request to credit a specified amount to the deposit account at the node with the communications system, wherein the request includes an indirect identification of the deposit account;
determining a direct identification of the deposit account with the processor from the indirect identification and from a nonpublic mapping stored on the storage device, the nonpublic mapping comprising a plurality of respective indirect identifications to respective direct identifications of respective deposit accounts; and
issuing a deposit instruction with the communications system to credit the deposit account with the specified amount in accordance with the determined direct identification.

19. The computer-readable storage medium recited in claim 18 wherein the instructions for receiving the request comprise instructions for receiving the request as routed from a second financial-services network that comprises a second plurality of interconnected nodes.

20. The computer-readable storage medium recited in claim 18 wherein the instructions for issuing the deposit instruction to credit the deposit account comprise instructions for transmitting the instruction for routing over a second financial-services network that comprises a second plurality of interconnected nodes.

21. The computer-readable storage medium recited in claim 18 wherein the instructions for receiving the request comprise instructions for receiving the request as routed from an automatic teller machine.

22. The computer-readable storage medium recited in claim 18 wherein the request does not include the direct identification.

23. The computer-readable storage medium recited in claim 18 wherein:
the request further includes an identification of a financial institution that maintains the deposit account; and
the instructions for issuing the deposit instruction comprise instructions for transmitting the deposit instruction for routing to a node comprised by the financial institution.

24. The computer-readable storage medium recited in claim 18 wherein the indirect identification is selected from the group consisting of a name of a holder of the deposit account, a name of a relative of the holder of the deposit account, a date meaningful to the holder of the deposit account, and a truncated portion of a numerical identifier of the holder of the deposit account.

25. The computer-readable storage medium recited in claim 18 wherein the direct identification of the deposit account comprises a primary account number for the deposit account.

26. The computer-readable storage medium recited in claim 18 wherein at least a portion of the nonpublic mapping is encrypted.

27. A financial-services network comprising a plurality of interconnected nodes, wherein a first of such nodes comprises a computational device having an input device, a communications system, a storage device, a processor, and a memory coupled with the processor, the memory comprising a computer-readable medium having a computer-readable program embodied therein for directing operation of the computational device, the computer readable program including:
instructions for receiving a request with the communications system from a second of such nodes to credit a specified amount to a deposit account identified with an indirect identification;
instructions for determining a direct identification of the deposit account with the processor from the indirect identification and from a nonpublic mapping stored on the storage device, the nonpublic mapping comprising a plurality of respective indirect identifications to respective direct identifications of respective deposit accounts; and
instructions for issuing a deposit instruction with the communications system to credit the deposit account with the specified amount in accordance with the determined direct identification.

28. The financial-services network recited in claim 27 wherein at least one of the plurality of interconnected nodes comprises a hub node and some of the plurality of interconnected nodes comprise ordinary nodes.

29. The financial-services network recited in claim 28 wherein the hub node is the first node.

30. The financial-services network recited in claim 27 wherein each of a plurality of the interconnected nodes is in direct communication with a second plurality of the interconnected nodes.

31. The financial-services network recited in claim 27 wherein the nonpublic mapping is comprised by a plurality of nonpublic mappings, each such nonpublic mapping being maintained at a different node of the financial-services network.

32. The financial-services network recited in claim 27 wherein at least some of the interconnected nodes comprise an automatic teller machine (“ATM”), whereby the financial-services network is an ATM network.

33. The financial-services network recited in claim 27 wherein at least a portion of the nonpublic mapping is encrypted.
